(19) United States
(12) Patent Application Publication
(10) Pub. No.: US 2014/0192537 A1
(43) Pub. Date: Jul. 10, 2014

(54) HEAT SINK AND LIGHTING APPARATUS HAVING SAME

(71) Applicants: Kil Yoan Chung, Suwon-si (KR); Seung Hwan Yu, Seoul (KR); Choul Ho Lee, Suwon-si (KR); Kwan Soo Lee, Seoul (KR)

(72) Inventors: Kil Yoan Chung, Suwon-si (KR); Seung Hwan Yu, Seoul (KR); Choul Ho Lee, Suwon-si (KR); Kwan Soo Lee, Seoul (KR)

(73) Assignee: SAMSUNG ELECTRONICS CO., LTD., Suwon-si, Gyeonggi-do (KR)

(21) Appl. No.: 14/240,288

(22) PCT Filed: Aug. 23, 2011
(86) PCT No.: PCT/KR2011/006209

§ 371 Date: Feb. 21, 2014

(51) Int. Cl. F21V 29/00; F28F 3/02

(52) U.S. Cl. CPC F21V 29/2262; F28F 3/02
USPC 362/294; 165/185

(57) ABSTRACT

Provided are a heat sink and a lighting apparatus having same, the heat sink including: a heat radiation plate having a mounting region formed on one side surface thereof on which a driving heat radiation element is mounted, and including a heat radiation hole formed in a central portion thereof, and including a heat radiation hole formed in a central portion thereof; and heat radiation fins provided on the other side surface of the heat radiation plate, and including a plurality of first heat radiation fins radially arranged in a circumferential direction and a plurality of second heat radiation fins having a length shorter than that of the first heat radiation fins and radially arranged between the first heat radiation fins.

### TECHNICAL FIELD

The present disclosure relates to a heat sink capable of improving heat radiation characteristics of a driving heat radiation element such as a light emitting diode (LED) used as a light source in a lighting apparatus, and a lighting apparatus having the same.

### BACKGROUND Art

A light emitting diode (LED) refers to a semiconductor device capable of implementing various colors of light by configuring a light emitting source through changing a compound semiconductor material such as GaAs, AlGaAs, GaN, InGaP or the like.

Such a light emitting diode (LED) has been widely used in devices and apparatuses within various fields of application such as in televisions (TVs), computers, lighting apparatuses, automobiles and the like, due to advantages thereof such as an excellent monochromatic peak wavelength, superior light extraction efficiency, miniaturizability, environmental friendliness, low power consumption thereof, and is widely spreading for use in various application fields.

In accordance with the recent awareness of the need to conserve energy, uses of incandescent lamps, low efficiency lighting devices, are regulated, and movements for replacing the incandescent lamps with high efficiency lighting devices such as LEDs have been actively undertaken mainly by LED manufacturers and lighting apparatuses.

Lighting apparatuses using such an LED as a light source have received positive responses due to advantages thereof such as relatively long lifespans as compared to existing incandescent lamps or halogen lamps.

However, LEDs may generate a great quantity of heat in accordance with an increase in a magnitude of current applied thereto, and such heat may deteriorate light emission efficiency and shorten lifespans of the LED.

In particular, when high temperature heat is not effectively emitted, deteriorations in the lifespan and performance of a device may be caused, such that a design for an efficient heat radiation structure is in demand.

### DISCLOSURE

### Technical Problem

An aspect of the present disclosure provides a heat sink capable of significantly improving heat radiation characteristics of a driving heat radiation element such as a light emitting diode (LED) used as a light source in a lighting apparatus and the like, and a lighting apparatus having the same.

### Technical Solution

According to an aspect of the present disclosure, there is provided a heat sink including: a heat radiation plate having a mounting region formed on one side surface thereof on which a driving heat radiation element is mounted, and including a heat radiation hole formed in a central portion thereof; and heat radiation fins provided on the other side surface of the heat radiation plate, and including a plurality of first heat radiation fins radially arranged in a circumferential direction and a plurality of second heat radiation fins having a length shorter than that of the first heat radiation fins and radially arranged between the first heat radiation fins.

The heat radiation fins may be extended from a circumferential portion of the heat radiation plate to the heat radiation hole formed in the central portion thereof.

The heat radiation fins may have a ratio L_{M}/L_{L} of a length L_{M} of the second heat radiation fins to a length L_{L} of the first heat radiation fins in a range of 0.4 to 0.7.

The heat radiation fins may further include a plurality of third heat radiation fins having a length shorter than that of the second heat radiation fins and radially arranged between the second heat radiation fins and the first heat radiation fins.

The heat radiation fins may have a ratio Lₛ/L_{L} of a length Lₛ of the third heat radiation fins to the length L_{L} of the first heat radiation fins in a range of 0.2 or less.

The heat radiation fins may have edges thereof extended from the central portion of the heat radiation plate and disposed to be perpendicular to the heat radiation plate along an optical axis, while being radially spaced apart from one another at a predetermined interval based on the heat radiation hole, to thereby form a cavity discharging air introduced into a central portion of the heat radiation plate along the heat radiation fins.

According to another aspect of the present disclosure, there is provided a lighting apparatus including: a light source module including at least one LED package and a substrate having the at least one LED package mounted thereon; a reflective unit including a forward hole having an open front surface and receiving the light source module therein such that the LED package is disposed toward the forward hole; a heat sink including a heat radiation plate having the light source module and the reflective unit mounted on one side surface thereof and including a heat radiation hole formed in a central portion thereof, and heat radiation fins provided on the other side surface of the heat radiation plate and including a plurality of first heat radiation fins radially arranged in a circumferential direction and a plurality of second heat radiation fins having a length shorter than that of the first heat radiation fins and radially arranged between the first heat radiation fins; and a cover member mounted on the forward hole of the reflective unit so as to protect the light source module.

The heat radiation fins may be extended from a circumferential portion of the heat radiation plate to the heat radiation hole formed in the central portion thereof.

The heat radiation fins may have a ratio L_{M}/L_{L} of a length L_{M} of the second heat radiation fins to a length L_{L} of the first heat radiation fins in a range of 0.4 to 0.7.

The heat radiation fins may further include a plurality of third heat radiation fins having a length shorter than that of the second heat radiation fins and radially arranged between the second heat radiation fins and the first heat radiation fins.

The heat radiation fins may have a ratio Lₛ/L_{L} of a length Lₛ of the third heat radiation fins to the length L_{L} of the first heat radiation fins in a range of 0.2 or less.

The lighting apparatus may further include a power supply unit mounted on the heat sink and supplying power to the light source module.

The reflective unit may further include a fixing ring mounted on the forward hole to thereby prevent the cover member and the light source module from being separated from the reflective unit.

### Advantageous Effects

Smooth air circulation may be induced through an optimized disposition of heat radiation fins having various lengths, such that heat radiating properties may be significantly increased.

### DESCRIPTION OF DRAWINGS

FIG. 1 is a schematic perspective view of a heat sink according to an exemplary embodiment of the present disclosure.

FIG. 2 is a plan view of the heat sink of FIG. 1.

FIG. 3 is a view schematically illustrating air flow in the heat sink of FIG. 1.

FIG. 4 is a schematic perspective view of a heat sink according to another exemplary embodiment of the present disclosure.

FIG. 5 is a plan view of the heat sink of FIG. 4.

FIG. 6 is a schematic view of a lighting apparatus according to an exemplary embodiment of the present disclosure.

### BEST MODE

A heat sink and a lighting apparatus having the same according to exemplary embodiments of the present disclosure will be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

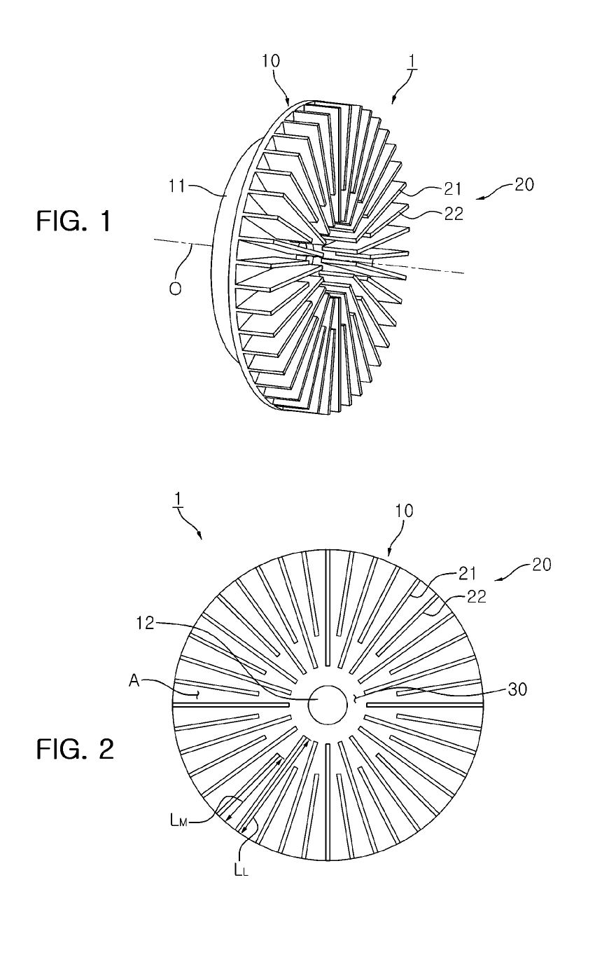

A heat sink according to an exemplary embodiment of the present disclosure will be described with reference to FIGS. 1 through 3.

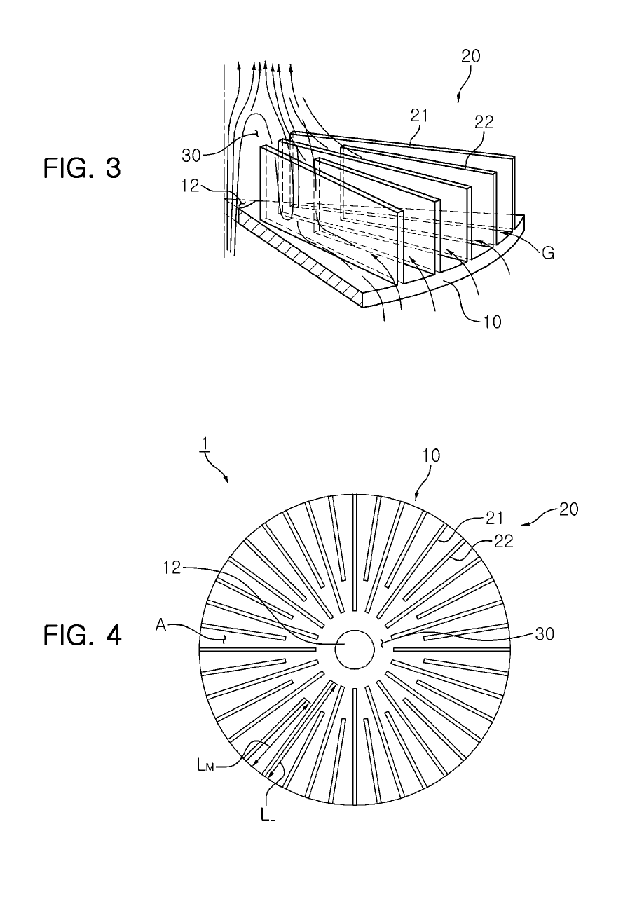

FIG. 1 is a schematic perspective view of a heat sink according to an exemplary embodiment of the present disclosure. FIG. 2 is a plan view of the heat sink of FIG. 1. FIG. 3 is a view schematically illustrating air flow in the heat sink of FIG. 1.

Referring to FIGS. 1 through 3, a heat sink 1 according to the exemplary embodiment of the present disclosure may include a heat radiation plate 10 and heat radiation fins 20.

The heat radiation plate 10 may have a driving heat radiation element, that is, a light source module 200 mounted on one side surface thereof to be fixedly supported thereby, the light source module 200 including at least one LED used as a light source for a lighting apparatus. The heat radiation plate 10 may receive and primarily emit high temperature heat generated by the light source module 200 to thereby cool the light source module 200.

Thus, the heat radiation plate 10 may be formed of a metal material having superior thermal conductivity such as aluminum in order to facilitate the smooth dissipation of heat, and may have a circular shape as illustrated in the drawings, but is not limited to having the shape according to the embodiment of the present disclosure. The heat radiation plate 10 may be variously formed according to a structure in which the heat radiation plate 10 is installed in a frame of a lighting apparatus (not shown).

In addition, the heat radiation plate 10 may include a heat radiation hole 12 formed in a central portion thereof to penetrate therethrough, such that heat generated from the light source module 200 may be directly transferred to the other side surface of the heat radiation plate 10.

The plurality of heat radiation fins 20 may be provided on the other side surface of the heat radiation plate 10, opposed to one side surface thereof having a mounting region in which the light source module 200 may be mounted, and may be radially arranged in a circumferential direction.

In the drawings, the plurality of heat radiation fins 20 have a rectangular panel shape, and may have one edges extended from a circumferential portion of the heat radiation plate 10 toward the heat radiation hole 12 formed in the central portion thereof while coming into contact with the heat radiation plate 10 to be perpendicular thereto.

In detail, the plurality of heat radiation fins 20 may include a plurality of first heat radiation fins 21 disposed at a predetermined interval and a plurality of second heat radiation fins 22 having a length shorter than that of the first heat radiation fins 21 and disposed between the first heat radiation fins 21. The plurality of heat radiation fins 20 may be arranged such that the plurality of first heat radiation fins 21 and the plurality of second heat radiation fins 22 disposed between the first heat radiation fins 21 are arranged in a radial manner. That is, the heat radiation fins having two different lengths, in particular, the first heat radiation fins 21 and the second heat radiation fins 22 having a length shorter than that of the first heat radiation fins 21 are alternately disposed in a radial manner while being spaced apart from one another at a predetermined interval.

In this case, in the plurality of heat radiation fins 20, a ratio L_{M}/L_{L} of a length L_{M} of the second heat radiation fins 22 to a length L_{L} of the first heat radiation fins 21 may be 0.4 to 0.7.

In light of heat transfer, the greater part of heat transfer may be generated in the heat radiation fins 20. Thus, when the number of the heat radiation fins 20 is increased, a heat transfer area may be increased to decrease an average temperature of the heat sink. However, sizes of an inlet area for cooling air and a passage area A between the heat radiation fins may be reduced to decrease an inflow rate of cooling air, and a temperature of cooling air may be rapidly increased toward an inner central portion of the heat radiation fins 20 to have a small difference in temperature from the heat radiation fins 20, thereby leading to a decrease in heat transfer. Thus, as the number of the heat radiation fins 20 is increased, since a decrease in the coefficient of heat transfer in accordance with a reduction in inflow rate of air may be greater than an increase in the coefficient of heat transfer in accordance with an increase in heat transfer area, the average temperature of the heat sink may be increased rather than being decreased.

In a similar manner, when the lengths of the heat radiation fins 20 are increased, the heat transfer area may be increased, such that the average temperature of the heat sink may be reduced. However, when the lengths of the heat radiation fins 20 reach a predetermined level or more, since the temperature of cooling air may be increased toward a central portion of the heat sink and may be similar to a temperature of the heat radiation fins 20, the average temperature of the heat sink may no longer be decreased. Therefore, as the lengths of the heat radiation fins 20 are increased, the coefficient of heat transfer may be increased in accordance with the increase in heat transfer area, but a local heat transfer coefficient may be decreased due to overheated air toward the central portion of the heat sink.

Thus, in the heat radiation fins 20 according to the exemplary embodiment of the present disclosure, the plurality of first and second heat radiation fins 21 and 22 having different lengths are alternately disposed in a radial manner to thereby increase the heat transfer area. Meanwhile, the average temperature of the heat sink may be decreased by preventing decreases in the inflow rate of cooling air and the passage area A between the heat radiation fins in central portion of the heat sink.

In addition, the ratio L_{M}/L_{L} of the length L_{M} of the second heat radiation fins 22 to the length L_{L} of the first heat radiation fins 21 may be 0.4 to 0.7. When a value of the ratio is smaller than 0.4, the heat transfer area may be decreased to thereby reduce the coefficient of heat transfer. On the other hand, when a value of the ratio is greater than 0.7, the passage area A in the central portion of the heat sink may be reduced to thereby decrease the inflow rate of cooling air and further, the temperature of cooling air may be increased in central portion of the heat sink, such that the average temperature of the heat sink 1 may be continuously increased.

Meanwhile, as illustrated in FIGS. 2 and 3, the heat radiation fins 20 have the edges thereof extended from the central portion of the heat radiation plate 10 and disposed to be perpendicular to the heat radiation plate 10 along an optical axis O, while being radially spaced apart from one another at a predetermined interval based on the heat radiation hole 12, to thereby form a cavity 30 discharging air introduced into the central portion of the heat radiation plate 10 along the heat radiation fins 20.

As in FIG. 3, the cavity 30 may be provided to induce a chimney effect to thereby enable heated air to be easily discharged to the outside, such that heated cooling air may rise in a vertical direction to be easily discharged to the outside.

The cooling air heated by the heat radiation fins 20 having a high temperature while being introduced to the central portion of the heat sink 1 from a peripheral portion thereof may have a density lower than that of the ambient air to thereby rise in an upward direction. In a region of the cavity 30 in which the heat radiation fins 20 are not provided, the velocity of the vertical component in the air may be increased, such that the air is not immobile and may be easily discharged to the outside.

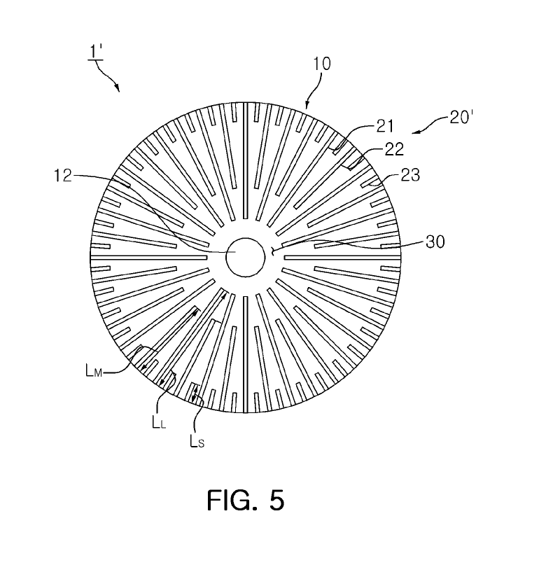

Referring to FIGS. 4 and 5, a heat sink according to another exemplary embodiment of the present disclosure will be described hereinafter.

FIG. 4 is a schematic perspective view of a heat sink according to another exemplary embodiment of the present disclosure. FIG. 5 is a plan view of the heat sink of FIG. 4.

As in the drawings, a heat sink 1′ according to another exemplary embodiment of the present disclosure may include the heat radiation plate 10 and heat radiation fins 20′. The overall structure of the heat sink 1′ is substantially identical to the example illustrated in FIG. 1. However, the heat radiation fins 20′ may further include a plurality of third heat radiation fins 23 having a length shorter than that of the second heat radiation fins 22 and radially arranged between the second heat radiation fins 22 and the first heat radiation fins 21, in addition to the first heat radiation fins 21 and the second heat radiation fins 22.

In detail, in the heat sink 1′ according to the exemplary embodiment of the present disclosure, the heat radiation fins 20′ may be arranged such that the plurality of first heat radiation fins 21 are radially arranged at a predetermined interval, the second heat radiation fins 22 having a length shorter than that of the first heat radiation fins 21 and disposed between the first heat radiation fins 21 are radially arranged, and the third heat radiation fins 23 having a length shorter than that of the second heat radiation fins 22 and disposed between the second heat radiation fins 22 and the first heat radiation fins 21 are radially arranged. That is, the heat radiation fins 20′ having three different lengths, in particular, the first heat radiation fins 21 having the greatest length and the second heat radiation fins 22 having the intermediate length, may be alternately disposed between the third heat radiation fins 23 having the shortest length, while being spaced apart from each other in a radial manner at a predetermined interval.

In this case, in the plurality of heat radiation fins 20′, a ratio Lₛ/L_{L} of a length Lₛ of the third heat radiation fins 23 to the length L_{L} of the first heat radiation fins 21 may be 0.2 or less. This is because, when a value of the ratio is equal to or greater than 0.2, the inlet area for cooling air and the passage area A between the heat radiation fins may be reduced to decrease an inflow rate of cooling air.

### MODE FOR DISCLOSURE

Hereinafter, computational heat transfer analysis results are compared with experimental results of heat radiation performance of a heat sink, whereby the validity thereof may be confirmed and an optimizing condition of the heat sink according to an example of the present disclosure may be considered.

<Comparison of Experimental Results and Computational Heat Transfer Analysis Results>

Experimentation on Heat Radiation Performance

In order to test heat radiation performance of a mass product model (6 inches, 20 W), a heat sink formed of an aluminum material and including a heat radiation plate having a diameter of 6 inches and twenty heat radiation fins, in particular, twenty first heat radiation fins, was used as a test subject.

The measurement of temperature was performed using a T-type thermocouple and a thermographic camera was used to examine emissivity and the overall temperature distribution. In the experimentation, the emissivity was indirectly compensated by allowing a temperature measured by the thermographic camera to be identical to a temperature accurately measured by the thermocouple while the emissivity was changed. The measurement of temperature was performed after a normal state in which a temperature was barely changed had reached, subsequently to an input of power to an LED module.

Heat Transfer Analysis

A heat sink including twenty heat radiation fins 20 in a similar manner to that of the heat sink used in the experimentation, and having a radius of 75 mm, the heat radiation fins 20 having a length of 55 mm, was used as a model, and an average temperature of the heat sink was analyzed.

A simple algorithm was selected in order to solve a flow field through a combination of pressure and velocity during numerical analysis, and only natural convection heat transfer was considered. In order to confirm the validity of the heat transfer analysis through the numerical analysis, the experimental results and the analysis results were compared in Table 1.

TABLE 1

| | Experimental | Computational Heat |
|---|---|---|
| | Results | Transfer Analysis |
| | (° C.) | Results (° C.) |
| Average | 38.8 | 39.48 |
| Temperature of | | |
| Heat Sink | | |
| Ambient | 18.5 | 18.5 |
| Temperature | | |

As in Table 1, it could be confirmed that the experimental results and the computational heat transfer analysis results were almost identical and thus, a computational heat transfer analysis was valid.

<Optimization of Heat Sink>

On the basis of the results, a heat sink structure having superior heat radiation performance was optimized through the computational heat transfer analysis. In order to select an optimal model, three models were used to perform numerical analysis, such that average temperatures of the heat sink were compared.

An LMS model included twenty first heat radiation fins 21 having the greatest length, twenty second heat radiation fins 22 having the intermediate length, and forty third heat radiation fins 23 having the shortest length. An LM model included twenty first heat radiation fins 21 and twenty second heat radiation fins 22. An L model only included twenty first heat radiation fins 21.

TABLE 2

| | LMS | LM | L |
|---|---|---|---|
| Average | 39.3° C. | 36.6° C. | 38.8° C. |
| Temperature of | | | |
| Heat Sink | | | |
| Ambient | 20.2° C. | 18.5° C. | 18.5° C. |
| Temperature | | | |
| Difference in | 19.1° C. | 18.1° C. | 20.3° C. |
| Average | | | |
| Temperature | | | |

It could be confirmed that the LMS model had the largest heat radiation area and the LM model had the lowest average temperature of the heat sink. In the case of the LMS model, the third heat radiation fins 23 were provided to allow for a relatively increased heat radiation area, but since the air flow between the heat radiation fins may be interrupted, thereby leading to a decrease in heat radiation performance.

In optimizing the heat sink structure on the basis of the analysis results, a combination of the heat radiation fins was performed using the LM model as a standard. During the optimization, design variables were selected as the number of the heat radiation fins 20 and the length of the second heat radiation fins 22, and an objective function was selected as a minimization in average temperature of the heat sink. Fixed variables were selected as a length of the first heat radiation fins 21, a diameter of the heat radiation plate 10, and a height of the heat radiation fins 20. The optimization was performed by calculating the number of the heat radiation fins and the length of the second heat radiation fins 22 when the average temperature of the heat sink is the minimum, using the central composite design.

It was calculated that the diameter of the heat radiation plate 10 was 6 to 8 inches, the length of the first heat radiation fins 21 was 0.6 to 0.8 times the radius of the heat radiation plate 10, the height of the heat radiation fins was 21.3 mm, and a heat value was 700 W/m², and the ambient temperature was 30° C., and the calculated results are indicated in Table 3.

TABLE 3

| inch | L_{L} (mm) | L_{M} (mm) | No. of Fins | T_{avg} (° C.) | L_{M}/L_{L} |
|---|---|---|---|---|---|
| 6 | 55 | 30 | 40 | 57.41 | 0.55 |
| 6 | 45 | 21 | 48 | 57.56 | 0.47 |
| 7 | 69 | 40 | 48 | 60.34 | 0.58 |
| 7 | 59 | 33 | 48 | 60.01 | 0.56 |
| 8 | 77 | 42 | 48 | 62.70 | 0.55 |
| 8 | 67 | 38 | 48 | 62.64 | 0.58 |

In the case of the heat sink including the heat radiation plate having a diameter of 6 to 8 inches, as described above, an optimal structure thereof was formed such that the heat radiation fins having two lengths, in particular, the first heat radiation fins 21 and the second heat radiation fins 22 were alternately disposed in a radial manner while being spaced apart from one another at a predetermined interval, on the heat radiation plate 10 having a circular plate structure. In this case, it could be confirmed that the optimal number of the heat radiation fins was 40 to 48, and the ratio L_{M}/L_{L} of the length L_{M} of the second heat radiation fins 22 to the length L_{L} of the first heat radiation fins 21 was 0.4 to 0.7.

Meanwhile, in addition to the LM model as described above, the LMS model further including the third heat radiation fins 23 may be used and in this case, the ratio Lₛ/L_{L} of the length Lₛ of the third heat radiation fins 23 to the length L_{L} of the first heat radiation fins 21 may be 0.2 or less.

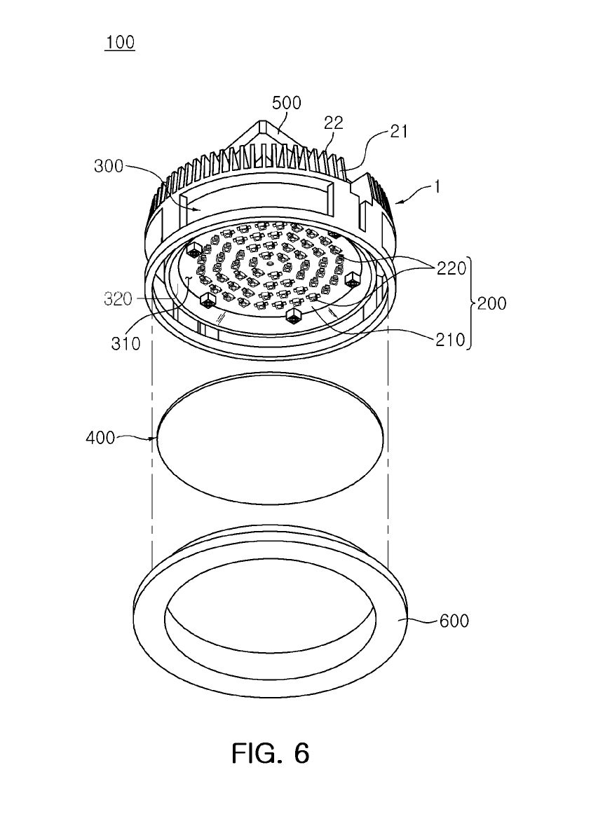

Referring to FIG. 6, a lighting apparatus according to an exemplary embodiment of the present disclosure will be described.

FIG. 6 is a schematic view of a lighting apparatus according to an exemplary embodiment of the present disclosure.

Referring to FIG. 6, a lighting apparatus 100 according to an exemplary embodiment of the present disclosure may include the light source module 200, a reflective unit 300, the heat sink 1, and a cover member 400 and further include a power supply unit (PSU) 500.

The light source module 200 may include at least one LED package 220 and a substrate 210 having the at least one LED package 220 mounted thereon.

In particular, the light source module 200 may employ an LED, a semiconductor device emitting light having a predetermined wavelength due to external power being applied thereto, and the LED package 220 may include a single LED or a plurality of LEDs therein.

The substrate 210, a kind of a printed circuit board (PCB), may be formed of an organic resin material containing epoxy, triazine, silicon, polyimide or the like and another organic resin material. Alternatively, the substrate 210 may be formed using a ceramic material such as AlN, Al₂O₃ or the like, or metal and metal compound materials. For example, the substrate 210 may be a metal core PCB (MCPCB), a type of metal PCB.

A circuit wiring (not shown) may be provided on a surface of the substrate 210, opposed to another surface thereof on which the LED package 220 is mounted, the circuit wiring being electrically connected to the LED package 220.

The reflective unit 300 may include a forward hole 310 having an open front and may receive the light source module 200 therein such that the LED package 220 is disposed toward the front of the reflective unit through the forward hole 310.

An inner circumferential surface 320 of the reflective unit 300 may be a surface inclined from a bottom surface thereof in which the light source module 200 is received, toward the forward hole 310, at a predetermined gradient, whereby light generated in the light source module 200 may be guided in a direction forward from the lighting apparatus and reflected light may be outwardly emitted through the forward hole 310.

The cover member 400 may be mounted in the forward hole 310 formed in the front surface of the reflective unit 300 in order to protect the light source module 200. The cover member 400 may be formed of a plastic material, a silica material, an acrylic material, a glass material or the like, and may be transparent in order to realize light transmissive properties.

In addition, the cover member 400 may contain a fluorescent material converting a wavelength of light emitted from the LED package 220 and may also contain a light dispersion material in order to diffuse light.

The reflective unit 300 may further include a fixing ring 600 mounted on the forward hole 310 to thereby prevent the cover member 400 and the light source module 200 from being separated from the reflective unit 300. The fixing ring 600 may be mounted to be easily detachable, such that the cover member 400 or the light source module 200 may be easily replaceable.

The rear surface (or the bottom surface) of the reflective unit 300, together with the light source module 200, may be coupled to the heat sink 1. In detail, the rear surface of the reflective unit 300 may be closed and form the cavity, together with the inner circumferential surface 320 thereof. The light source module 200 may be mounted on the heat radiation plate 10 of the heat sink 1 through the reflective unit 300 in a state in which the light source module 200 is included in the reflective unit 300.

However, the present disclosure is not limited, and the rear surface of the reflective unit 300 is opened, such that the rear surface and the forward hole 310 may penetrate through the reflective unit 300. In this case, the light source module 200 may be directly mounted on the heat radiation plate 10 of the heat sink 1 and the reflective unit 300 may be mounted on the heat radiation plate 10 while covering the circumference of the light source module 200.

Since a detailed description of the heat sink 1 has been made in connection with FIGS. 1 through 5, the explanation thereof will be omitted.

Meanwhile, the power supply unit 500 may be mounted on the heat sink 1 and supply power to the LED package 220 through the circuit wiring (not shown) provided on the substrate 210 of the light source module 200.

Specifically, the power supply unit 500 may be provided on the heat radiation fins 20 of the heat sink 1 to be electrically connected to the circuit wiring of the substrate 210 through the heat radiation hole 12 of the heat radiation plate 10, and may include a switching mode power supply (SMPS) and the like.

1. A heat sink comprising:
a heat radiation plate having a mounting region formed on one side surface thereof on which a driving heat radiation element is mounted, and including a heat radiation hole formed in a central portion thereof; and
heat radiation fins provided on the other side surface of the heat radiation plate, and including a plurality of first heat radiation fins radially arranged in a circumferential direction and a plurality of second heat radiation fins having a length shorter than that of the first heat radiation fins and radially arranged between the first heat radiation fins.

2. The heat sink of claim 1, wherein the heat radiation fins are extended from a circumferential portion of the heat radiation plate to the heat radiation hole formed in the central portion thereof.

3. The heat sink of claim 1, wherein the heat radiation fins have a ratio L_{M}/L_{L} of a length L_{M} of the second heat radiation fins to a length L_{L} of the first heat radiation fins in a range of 0.4 to 0.7.

4. The heat sink of claim 1, wherein the heat radiation fins further include a plurality of third heat radiation fins having a length shorter than that of the second heat radiation fins and radially arranged between the second heat radiation fins and the first heat radiation fins.

5. The heat sink of claim 4, wherein the heat radiation fins have a ratio Lₛ/L_{L} of a length Lₛ of the third heat radiation fins to the length L_{L} of the first heat radiation fins in a range of 0.2 or less.

6. The heat sink of claim 1, wherein the heat radiation fins have edges thereof extended from the central portion of the heat radiation plate and disposed to be perpendicular to the heat radiation plate along an optical axis, while being radially spaced apart from one another at a predetermined interval based on the heat radiation hole, to thereby form a cavity discharging air introduced into a central portion of the heat radiation plate along the heat radiation fins.

7. A lighting apparatus comprising:
a light source module including at least one LED package and a substrate having the at least one LED package mounted thereon;
a reflective unit including a forward hole having an open front and receiving the light source module therein such that the LED package is disposed toward the forward hole;
a heat sink including a heat radiation plate having the light source module and the reflective unit mounted on one side surface thereof and including a heat radiation hole formed in a central portion thereof, and heat radiation fins provided on the other side surface of the heat radiation plate and including a plurality of first heat radiation fins radially arranged in a circumferential direction and a plurality of second heat radiation fins having a length shorter than that of the first heat radiation fins and radially arranged between the first heat radiation fins; and
a cover member mounted on the forward hole of the reflective unit so as to protect the light source module.

8. The lighting apparatus of claim 7, wherein the heat radiation fins are extended from a circumferential portion of the heat radiation plate to the heat radiation hole formed in the central portion thereof.

9. The lighting apparatus of claim 7, wherein the heat radiation fins have a ratio L_{M}/L_{L} of a length L_{M} of the second heat radiation fins to a length L_{L} of the first heat radiation fins in a range of 0.4 to 0.7.

10. The lighting apparatus of claim 7, wherein the heat radiation fins further include a plurality of third heat radiation fins having a length shorter than that of the second heat radiation fins and radially arranged between the second heat radiation fins and the first heat radiation fins.

11. The lighting apparatus of claim 10, wherein the heat radiation fins have a ratio Lₛ/L_{L} of a length Lₛ of the third heat radiation fins to the length L_{L} of the first heat radiation fins in a range of 0.2 or less.

12. The lighting apparatus of claim 7, further comprising a power supply unit mounted on the heat sink and supplying power to the light source module.

13. The lighting apparatus of claim 7, wherein the reflective unit further includes a fixing ring mounted on the forward hole to thereby prevent the cover member and the light source module from being separated from the reflective unit.
